(19) United States
(12) Patent Application Publication
(10) Pub. No.: US 2022/0230383 A1
(43) Pub. Date: Jul. 21, 2022

(54) OCCLUSION AND COLLISION DETECTION FOR AUGMENTED REALITY APPLICATIONS

(71) Applicant: GUANGDONG OPPO MOBILE TELECOMMUNICATIONS CORP., LTD., Dongguan (CN)

(72) Inventors: Yuan Tian, Palo Alto, CA (US); Yi Xu, Palo Alto, CA (US); Yuxin Ma, Palo Alto, CA (US); Shuxue Quan, Palo Alto, CA (US)

(21) Appl. No.: 17/714,918

(22) Filed: Apr. 6, 2022

Related U.S. Application Data
(63) Continuation of application No. PCT/CN2020/118778, filed on Sep. 29, 2020.
(60) Provisional application No. 62/911,897, filed on Oct. 7, 2019.

(51) Int. Cl. G06T 15/40; G06T 19/00

(52) U.S. Cl. CPC G06T 15/40; G06T 2210/21; G06T 2207/10028; G06T 19/006

(57) ABSTRACT

Techniques for occlusion and collision detection in an AR session are described. In an example, a depth sensor is used to generate a depth image. Distortions in the depth image are reduced or eliminated by at least dividing the depth image into depth layers and moving depth pixels between the layers. An RGBD image is generated from the depth image, as updated, and an RGB image generated at substantially the same time as the depth image. Occlusion of a virtual object is detected based on the RGBD image. Further, a 3D model of the real-world environment is generated from the depth images, as updated, and includes multi-level voxels. Collision with the virtual object is detected based on the multi-level voxels. Rendering of the virtual object in an AR session is based on the occlusion and collision detection.

### CROSS-REFERENCE TO RELATED APPLICATIONS

This application is a continuation of International Application No. PCT/CN2020/118778, filed on Sep. 29, 2020, which claims priority to U.S. Application No. 62/911,897, filed on Oct. 7, 2019. The disclosures of the aforementioned applications are hereby incorporated by reference in their entireties.

### BACKGROUND

Augmented Reality (AR) superimposes virtual contents on top of a user's view of the real world. With the development of AR software development kits (SDK), the mobile industry has brought smartphone AR to mainstream. An AR SDK typically provides six degrees-of-freedom (6DoF) tracking capability. A user can scan the environment using a smartphone's camera, and the smartphone performs visual inertial odometry (VIO) in real time. Once the camera pose is tracked continuously, virtual objects can be placed into the AR scene to create an illusion that real objects and virtual objects are merged together. IO systems only create a sparse representation of the real world.

When placing a virtual object into an AR scene, it is important that the placement is accurate and performed in real time. Otherwise, the presentation of the virtual object suffers from low quality.

### SUMMARY

The present invention relates generally to methods and systems related to augmented reality applications. More particularly, embodiments of the present invention provide methods and systems for performing occlusion and collision detection in AR environments. The invention is applicable to a variety of applications in augmented reality and computer-based display systems.

Techniques for occlusion and collision detection in an AR session are described. In an example, a computer system is used for the occlusion and collision detection. The computer system is configured to perform various operations. The operations include generating, in an augmented reality (AR) session and based on a depth sensor of the computer system, a depth image. The operations also include dividing the depth image into depth layers, each depth layer corresponding to a depth range and including pixels having depth values within the depth range. The operations also include selecting, from the depth layers, a first depth layer having a first layer number and a second depth layer having a second layer number. The operations also include adjusting the first depth layer based on the first layer number, first pixels in the first depth layer, the second layer number, and second pixels in the second depth layer. The adjusting includes moving a pixel from the second depth layer to the first depth layer. The operations also include updating the depth image based on the adjusting. The operations also include outputting the depth image as updated to at least one AR application associated with the AR session.

In an example, a total number of the depth layers is based on a maximum depth of the depth sensor. A difference between depth ranges of two consecutive depth layers is between 0.4 meters and 0.6 meters. The first depth layer and the second depth layer are selected based on a difference between the first layer number and the second layer number being equal to or larger than two. The first depth layer and the second depth layer are selected further based on each of a total number of the first pixels and a total number of the second pixels being equal to or larger than a predefined threshold number. The first layer number is larger than the second layer number. Adjusting the first depth layer includes performing a morphological dilation from the first depth layer to the second depth layer. A size of a kernel of the morphological dilation is based on a difference between the first layer number and the second layer number. The morphological dilation is iteratively repeated for a number of iterations, and wherein the number of iterations is based on a difference between the first layer number and the second layer number.

In an example, the operations also include generating, in the AR session and based on a red, blue, and green (RGB) optical sensor of the computer system, an RGB image; generating, based on the depth image as updated and the RGB image, an RGB depth (RGBD) image; generating, based on the depth image as updated, a set of three dimensional (3D) points in a coordinate system of the AR session; generating, based on the depth image, a 3D model that includes multi-level voxels. A multi-level voxel of the multi-level voxels is associated with a 3D point from the set. The operations also include determining a collision between a virtual object and the multi-level voxel; and rendering, in the AR session, the virtual object based on a depth of the virtual object and the RGBD image and based on the collision.

In an example, A computer system includes a depth sensor configured to generate a depth image in an augmented reality (AR) session, a red, blue, and green (RGB) optical sensor configured to generate an RGB image in the AR session, one or more processors, and one or more memories storing computer-readable instructions that, upon execution by the one or more processors, configure the computer system to perform operations. The operations include updating the depth image by at least dividing the depth image into depth layers and moving a pixel from a first depth layer to a second depth layer of the depth layers; generating, based on the depth image as updated and the RGB image, an RGB depth (RGBD) image; generating, based on the depth image as updated, a set of three dimensional (3D) points in a coordinate system of the AR session; generating a 3D model that includes multi-level voxels, wherein a multi-level voxel of the multi-level voxels is associated with a 3D point from the set; determining a collision between a virtual object and the multi-level voxel; and rendering, in the AR session, the virtual object based on a depth of the virtual object and the RGBD image and based on the collision.

In an example, each depth layer corresponds to a depth range and includes pixels having depth values within the depth range. Updating the depth image further includes: selecting, from the depth layers, the first depth layer and the second depth layer based on a first layer number of the first depth layer and on a second layer number of the second depth layer; and adjusting the second depth layer based on the first layer number, first pixels in the first depth layer, the second layer number, and second pixels in the second depth layer. The adjusting includes moving the pixel from the first depth layer to the second depth layer.

In an example, generating the RGBD image includes: registering the depth image with the RGB image based on an image resolution of the depth image, an image resolution of the RGB image, and a transformation between the depth sensor and the RGB optical sensor; performing a depth densification on the depth image, the depth densification including a plurality of morphological dilation on the depth image; filtering, subsequent to the depth densification, the depth image based on a median filter; and up-sampling the depth image as filtered to the image resolution of the RGB image based on the registering. A pixel in the RGBD image corresponds to pixel in the RGB image and a pixel in the depth image as up-sampled.

In an example, rendering the virtual object includes: generating an alpha map from the depth image; and up-sampling the depth image and the alpha map to an image resolution of the RGB image. In this example, rendering the virtual object includes: determining that a pixel to be rendered in an AR image corresponds to a first pixel of the RGBD image and to a second pixel of the virtual object; determining, from the RGBD image, a first depth of the first pixel; determining that the first depth is smaller than or equal to a second depth of the second pixel; generating a smoothing factor for the first pixel based on the alpha map; and setting an RGB value for the pixel in the AR image based on a first RGB value of the first pixel, a second RGB value of the second pixel, and the smoothing factor. The smoothing factor is set as α=1−mᵢ/255, and wherein the RGB value is set as cᵢ^{r}=(1−α)cᵢ+αcᵢ^{o}, and where “α” is the smoothing factor, “i” is the pixel, a “mᵢ” is a value determined for the pixel from the alpha map, “cᵢ^{r}” is the RGB value, “cᵢ” is the first RGB value, and “cᵢ^{o}” is the second RGB value.

In an example, rendering the virtual object includes: determining that a pixel to be rendered in an AR image corresponds to a first pixel of the RGBD image and to a second pixel of the virtual object; determining, from the RGBD image, a first depth of the first pixel; determining that the first depth is larger than a second depth of the second pixel; and setting an RGB value for the pixel in the AR image to be equal to an RGB value of the second pixel.

In an example, one or more non-transitory computer-storage media store instructions that, upon execution on a computer system, cause the computer system to perform operations. The operations include: generating, in an augmented reality (AR) session and based on a depth sensor of the computer system, a depth image; generating, in the AR session and based on a red, blue, and green (RGB) optical sensor of the computer system, an RGB image; updating the depth image by at least dividing the depth image into depth layers and moving a pixel from a first depth layer to a second depth layer of the depth layers; generating, based on the depth image as updated and the RGB image, an RGB depth (RGBD) image; generating, based on the depth image as updated, a set of three dimensional (3D) points in a coordinate system of the AR session; generating a 3D model that includes multi-level voxels. A multi-level voxel of the multi-level voxels is associated with a 3D point from the set. The operations also include determining a collision between a virtual object and the multi-level voxel; and rendering, in the AR session, the virtual object based on a depth of the virtual object and the RGBD image and based on the collision.

In an example, the set of 3D points includes a point cloud. The multi-level voxel includes a first voxel at a first level that has a first grid size and second voxels at a second level that has a second grid size smaller than the first grid size. In this example, generating the 3D model includes: dividing coordinates of the 3D point by the first grid size to generate indexes of the 3D point; hashing the indexes to determine a hash value; determining that a hash map does not include the hash value; and updating the hash map to include the hash value.

In an example, rendering the virtual object includes preventing the collision from being rendered by at least controlling movement of the virtual object. The multi-level voxel includes a first voxel at a first level that has a first grid size and second voxels at a second level that has a second grid size smaller than the first grid size. Determining the collision includes: generating one or more bounding boxes around the virtual object; determining a first intersection between the one or more bounding boxes and the first voxel; determining, based on the first intersection, that the first voxel has a first hash value in a hash map; determining, based on the first hash value being included in the hash map, a second intersection between the one or more bounding boxes and a second voxel from the second voxels; determining, based on the second intersection, that the second voxel has a second hash value in the hash map; and detecting the collision based on the second hash value being included in the hash map.

In an example, the multi-level voxel includes a first voxel at a first level that has a first grid size and second voxels at a second level that has a second grid size smaller than the first grid size. In this example, determining the collision includes: storing, in association with a second voxel from the second voxels, a sequenced queue that includes bits. Each bit is associated with a different depth image and indicates whether the second voxel corresponds to a 3D point that is visible in the different depth image. Determining the collision also includes removing an end bit from an end of the sequenced queue; inserting a start bit at a start of the sequences queue, wherein the start bit is associated with the depth image; determining that a total number of bits in the sequenced queue indicating that the second voxel is visible is larger than a predefined threshold number; and detecting the collision based on the second voxel.

Numerous benefits are achieved by way of the present invention over conventional techniques. For example, embodiments of the present invention provide methods and systems that provide accurate and real-time occlusion and collision detection, at relatively low processing and storage usage. The occlusion and collision detection improve the quality of an AR scene rendered in an AR session. These and other embodiments of the invention along with many of its advantages and features are described in more detail in conjunction with the text below and attached figures.

### BRIEF DESCRIPTION OF DRAWINGS

Various embodiments in accordance with the present disclosure will be described with reference to the drawings, in which:

FIG. 1 illustrates an example of a computer system that includes a depth sensor and a red, green, and blue (RGB) optical sensor for AR applications, according to at least one aspect of the disclosure;

FIG. 2 illustrates an example of an AR scene based on occlusion and collision rendering, according to at least one aspect of the disclosure;

FIG. 3 illustrates an example of an AR module for occlusion and collision rendering, according to at least one aspect of the disclosure;

FIG. 4 illustrates an example of depth map processing to update a depth image, according to at least one aspect of the disclosure;

FIG. 5 illustrates an example of an update to a depth image, according to at least one aspect of the disclosure;

FIG. 6 illustrates an example of a registration of a depth image with an RGB image, according to at least one aspect of the disclosure;

FIG. 7 illustrates an example of rendering an AR scene based on occlusion detection that uses an RGBD image, according to at least one aspect of the disclosure;

FIG. 8 illustrates an example of a three dimensional (3D) model of a real-world environment and a bounding box of a virtual object, according to at least one aspect of the disclosure;

FIG. 9 illustrates an example of a hashing representation of a multi-level voxel, according to at least one aspect of the disclosure;

FIG. 10 illustrates an example of a flow for AR scene rendering based on occlusion and collision detections, according to at least one aspect of the disclosure;

FIG. 11 illustrates an example of a flow for updating a depth image, according to at least one aspect of the disclosure;

FIG. 12 illustrates an example of a flow for occlusion detection, according to at least one aspect of the disclosure;

FIG. 13 illustrates an example of a flow for collision detection, according to at least one aspect of the disclosure; and

FIG. 14 illustrates an example computer system, according to embodiments of the present disclosure.

### DESCRIPTION OF EMBODIMENTS

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, accurate and real-time detection of occlusions and collisions between virtual objects and between virtual objects and real-world objects to facilitate the rendering of an AR scene without the need for visual markers or features of the real-world objects. Occlusion and collision detection can rely on dense depth data in real time. However, it is challenging to generate such information solely from a single red, green, and blue (RGB) camera.

In embodiments of the present disclosure, a depth sensor, such as a time-of-flight (ToF) camera, is used to acquire depth data and generate a depth image. For instance, a ToF camera measures the round trip time of emitted light and resolves the depth value (distance) for a point in the real-world scene. Such cameras can provide dense depth data at thirty to sixty frames per second (fps).

There are many critical technical challenges for applying depth data to visual occlusion and collision detection. First, AR applications typically necessitate real-time performance using limited computing resources. Second, ToF cameras have a unique sensing architecture, and contain systematic and non-systematic bias. Specifically, depth maps captured by ToF cameras have low depth precision and low spatial resolution, and there are errors caused by radiometric, geometric and illumination variations. Furthermore, the depth maps also need to be up-sampled and registered to the resolution of RGB camera to enable AR applications.

Embodiments of the present disclosure involve a processing pipeline that uses the RGB and ToF cameras on a computer system (e.g., a smartphone, a tablet, an AR headset, or the like) to compute visual occlusion and collision detection. The ToF depth maps are processed to remove outliers and overcome sensor bias and errors. Then a densification algorithm is applied to up-sample the low-resolution depth map to a resolution of an RGB image. An alpha map is also generated for blending between virtual objects and real objects along the occluding boundaries. A light-weighted voxelization representation of the real-world scene is also generated from the depth maps to enable fast collision detection. Accordingly, embodiments of the present disclosure describe a system that exploits a depth sensor (e.g., a ToF camera) on a computer system for multiple AR applications with computational efficiency and very good visual performance. The computer system is configured for depth map processing that removes outlier, densifies the depth map, and enables blending at the occlusion boundaries between real objects and virtual objects. The computer system is also configured to generate a light-weighted 3D representation of a scene and perform a collision detection based on multi-level voxels.

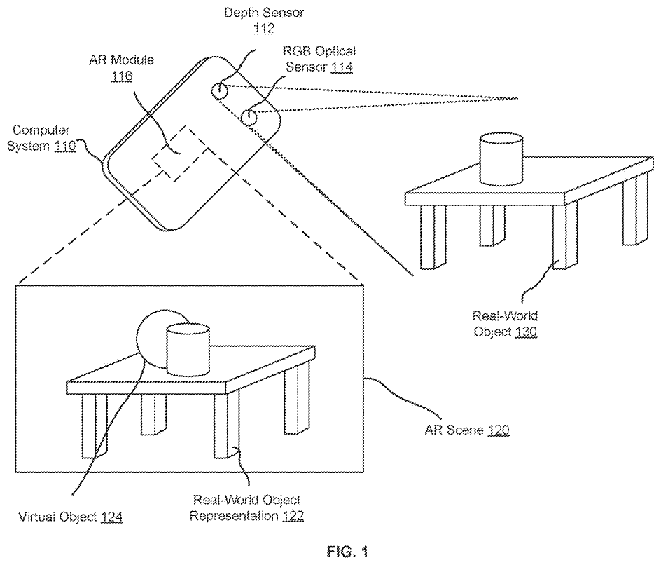

FIG. 1 illustrates an example of a computer system 110 that includes a depth sensor 112 and an RGB optical sensor 114 for AR applications, according to at least one aspect of the disclosure. The AR applications can be implemented by an AR module 116 of the computer system 110. Generally, the RGB optical sensor 114 generates an RGB image of a real-world environment that includes, for instance, a real-world object 130. The depth sensor 112 generates depth data about the real-world environment, where this data includes, for instance, a depth map that shows depth(s) of the real-world object 130 (e.g., distance(s) between the depth sensor 112 and the real-world object 130). Following an initialization of an AR session (where this initialization can include calibration and tracking), the AR module 116 renders an AR scene 120 of the of the real-world environment in the AR session, where this AR scene 120 can be presented at a graphical user interface (GUI) on a display of the computer system 110. The AR scene 120 shows a real-world object representation 122 of the real-world object 130. In addition, the AR scene 120 shows a virtual object 124 not present in the real-world environment. The AR module 116 can generate an a red, green, blue, and depth (RGBD) image from the RGB image and the depth map to detect an occlusion of the virtual object 124 by at least a portion of the real-world object representation 122 or vice versa. The AR module 116 can additionally or alternatively generate a 3D model of the real-world environment based on the depth map, where the 3D model includes multi-level voxels. Such voxels are used to detect collision between the virtual object 124 and at least a portion of the real-world object representation 122. The AR scene 120 can be rendered to properly show the occlusion and avoid the rendering of the collision.

In an example, the computer system 110 represents a suitable user device that includes, in addition to the depth sensor 112 and the RGB optical sensor 114, one or more graphical processing units (GPUs), one or more general purpose processors (GPPs), and one or more memories storing computer-readable instructions that are executable by at least one of the processors to perform various functionalities of the embodiments of the present disclosure. For instance, the computer system 110 can be any of a smartphone, a tablet, an AR headset, or a wearable AR device.

The depth sensor 112 has a known maximum depth range (e.g., a maximum working distance) and this maximum value may be stored locally and/or accessible to the AR module 116. The depth sensor 112 can be a ToF camera. In this case, the depth map generated by the depth sensor 112 includes a depth image. The RGB optical sensor 114 can be a color camera. The depth image and the RGB image can have different resolutions. Typically, the resolution of the depth image is smaller than that of the RGB image. For instance, the depth image has a 240×180 resolution, whereas the RGB image has a 1920×1280 resolution.

In addition, the depth sensor 112 and the RGB optical sensor 114, as installed in the computer system 110, may be separated by a transformation (e.g., distance offset, field of view angle difference, etc.). This transformation may be known and its value may be stored locally and/or accessible to the AR module 116. When cameras are used, the ToF camera and the color camera can have similar field of views. But because of the transformation, the field of views would partially, rather than fully, overlap.

The AR module 116 can be implemented as specialized hardware and/or a combination of hardware and software (e.g., general purpose processor and computer-readable instructions stored in memory and executable by the general purpose processor). In addition to initializing an AR session and performing VIO, he AR module 116 can detect occlusion and collision to properly render the AR scene 120.

In an illustrative example of FIG. 1, a smartphone is used for an AR session that shows the real-world environment. In particular, the AR session includes rendering an AR scene that includes a representation of a real-world table on top of which a vase (or some other real-world object) is placed. A virtual ball (or some other virtual object) is to be shown in the AR scene. In particular, the virtual ball is to be shown on top of the table too. By tracking the occlusion between the virtual ball and a virtual vase (that represents the real-world vase), the virtual vase can occlude, in parts of the AR scene, when the virtual ball is behind the virtual vase relative to the pose of the smartphone. In other parts of the AR scene, the virtual ball can occlude the virtual vase when the virtual vase is behind the virtual ball relative to a change in the pose of the smartphone. And in remaining parts of the AR scene, no occlusion is present. In addition, a user of the smartphone can interact with the virtual ball to move the virtual ball on the top surface of the virtual table (that represents the real-world table). By tracking possible collision between the virtual ball and the virtual object, any interaction that would cause collision would not be rendered. In other words, the collision tracking can be used to control where the virtual ball can be moved in the AR scene.

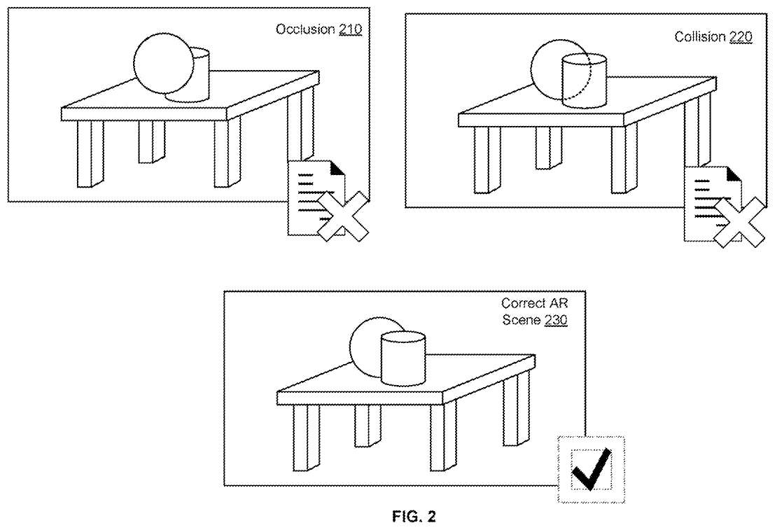

FIG. 2 illustrates an example of an AR scene based on occlusion and collision rendering, according to at least one aspect of the disclosure. As illustrated, different AR scenes are possible, but only one of the scenes may properly show the occlusion and avoid collision. Herein, a virtual object is described as being occluded by a representation of a real-world object. Also, a collision of the virtual object with the real-world object representation is described. However, embodiments of the present disclosure are not limited as such and apply to an occlusion of the real-world object representation by the virtual object and/or a collision of the real-world object representation with the virtual object. The embodiments similarly apply to occlusion between virtual objects and/or to collisions between virtual objects.

As illustrated in the top left side of FIG. 2, a first AR scene can be rendered, where this AR scene does not account for occlusion 210. In particular, the virtual object (illustrated as a sphere) should be occluded by the real-world object representation (shown as a cylinder). However, in the first AR scene, the virtual object is incorrectly rendered as having a smaller depth than the real-world object representation and, thus, incorrectly appears to occlude the real-world object representation.

As illustrated in the top right side of FIG. 2, a second AR scene can be rendered, where this AR scene does not account for collision 220. In particular, the virtual object (also illustrated as a sphere) should not collide with the real-world object representation (also shown as a cylinder). However, in second the AR scene, the virtual object is incorrectly having a same depth as and being the same virtual space as the real-world object representation and, thus, incorrectly appears to collide with the real-world object representation.

As illustrated in the bottom center of FIG. 2, a correct AR scene 230 can be rendered, where this correct AR scene 210 accounts for occlusion and collision. The AR scene 230 is an example of the AR scene 120 of FIG. 1. In the correct AR scene 230, the virtual object (also illustrated as a sphere) is shown as being occluded by the real-world object representation (also shown as a cylinder). In addition, the virtual object is shown as not colliding with the real-world object representation. Embodiments of the present disclosure involve occlusion and collision detection to support the rendering of correct AR scenes, such as the correct AR scene 230.

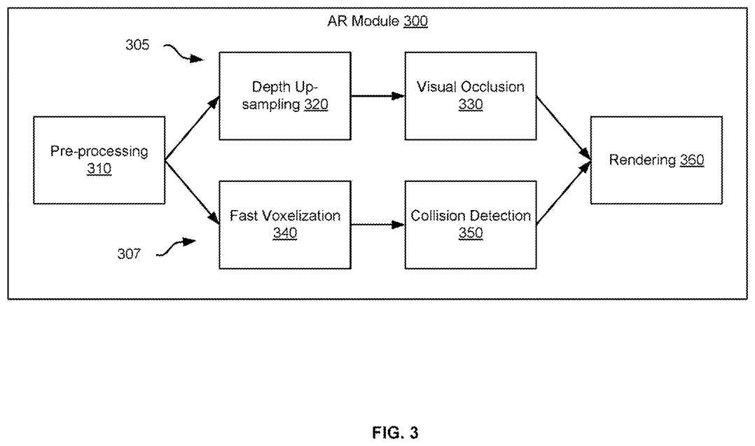

FIG. 3 illustrates an example of an AR module 300 for occlusion and collision rendering, according to at least one aspect of the disclosure. The AR module 300 is an example of the AR module 116 of FIG. 1 and includes multiple computing components, such as a pre-processing component 310, a depth up-sampling component 320, a visual occlusion component 330, a fast voxelization component 340, a collision detection component 350, and a rendering component 360. Each of such computing components 310-360 can be implemented as specialized hardware and/or a combination of hardware and software.

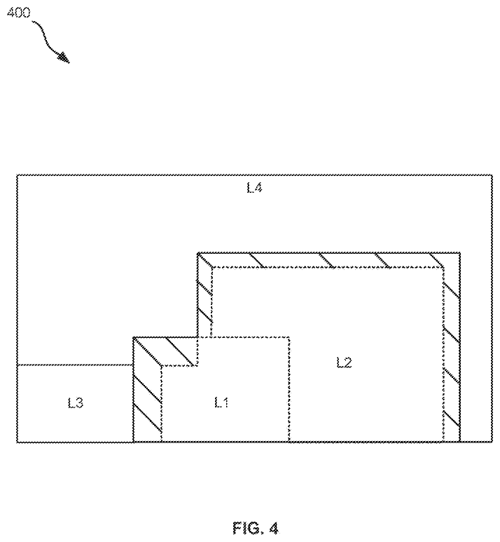

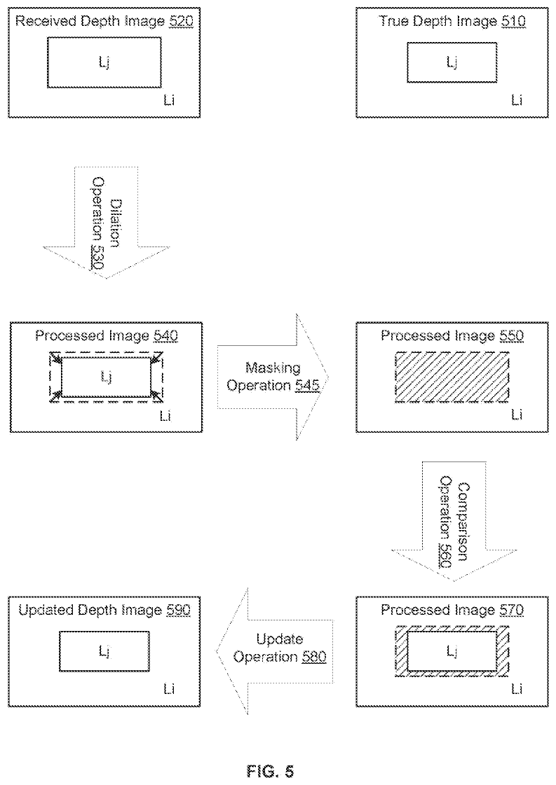

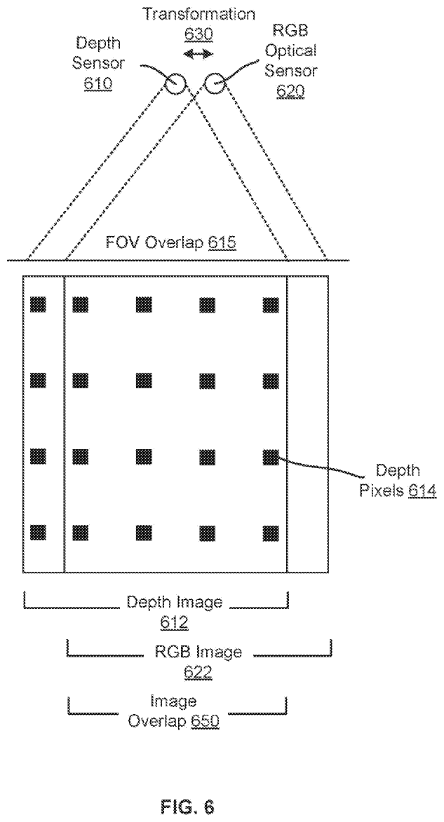

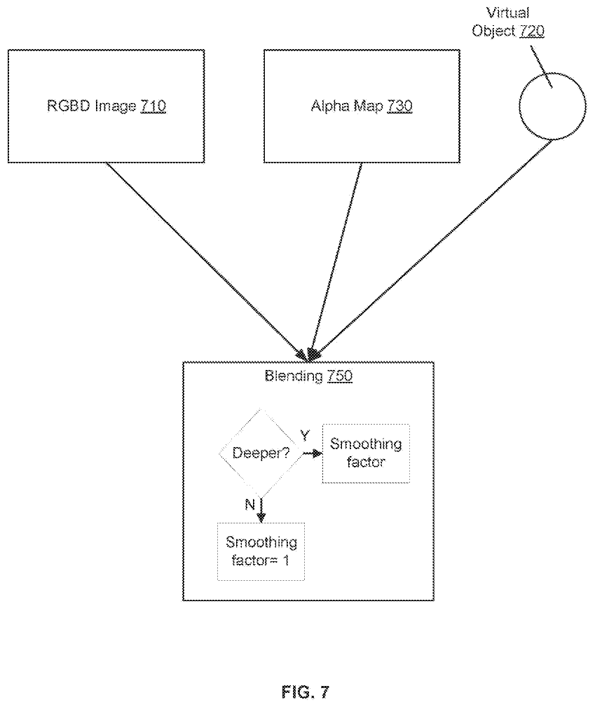

The pre-processing component 310 processes a depth map (e.g., a depth image generated based on measurements made using a ToF camera) to remove outliers. Such processing is further illustrated in FIGS. 4-5. The processed depth map is further processed in two streams 305 and 307. Streams 305 and 307 can be performed in parallel to reduce the processing latency. In stream 305, depth up-sampling is performed by the depth up-sampling component 320 to generate high-resolution depth map. This high-resolution map is used by the visual occlusion component 330 to detect occlusions and the output of the occlusion detection can be provided to the rendering component 360 for occlusion rendering. FIGS. 6-7 further illustrate the processing of stream 305.

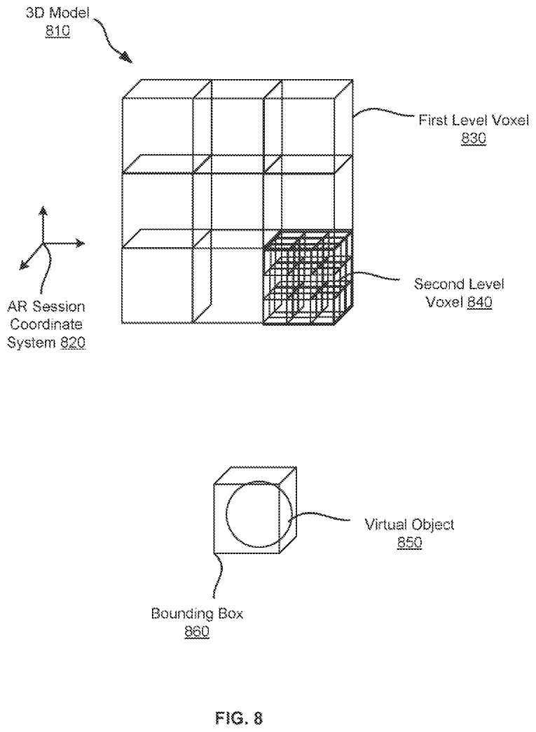

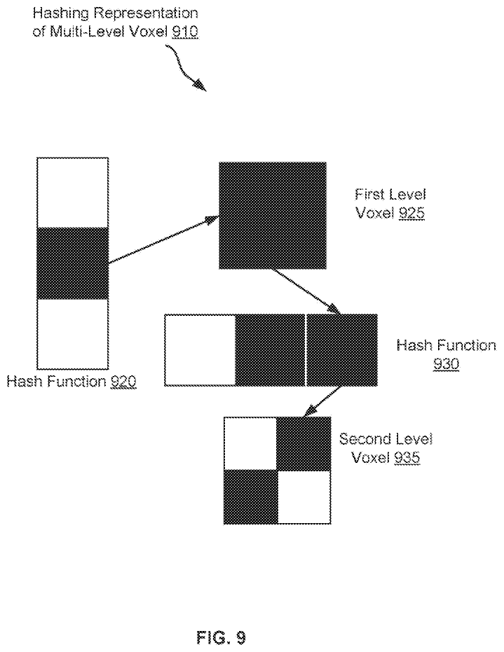

In stream 307, the fast voxelization component 340 converts the real-world scene into a 3D representation for collision detection, where the conversion relies on the processed depth map. The 3D representation includes multi-level voxels that are used by the collision detection component 350 to detect collisions and the output of the collision detection can be provided to the rendering component 360 for collision rendering (e.g., to avoid the presentation of collisions). FIGS. 8-9 further illustrate the processing of stream 307.

FIG. 4 illustrates an example of depth map processing to update a depth image 400, according to at least one aspect of the disclosure. Here, the depth image 400 is generated by a ToF camera, which is an example of a depth sensor. The update can be performed by, for instance, the pre-processing component 310 of FIG. 3.

In particular, both visual occlusion and collision detection necessitate that each pixel of the RGB image has a reasonable depth value. However, depth data from the ToF camera is often quite noisy due to systematic and non-systematic errors. Specifically, systematic errors include infra-red (IR) demodulation error, amplitude ambiguity and temperature error. Usually, longer exposure time increases signal-to-noise ratio (SNR); however, this will lower the frame rate.

In a typical AR application, a user often moves the ToF camera slowly. Therefore, outliers due to IR saturation and 3D structure distortion are dominant. Such outliers exist along the depth discontinuity between foreground and background. Specifically, pixels on background objects along the occlusion boundary tend to have abnormally smaller depth value. The larger the depth gap between background and foreground is, the larger the affected region. Accordingly, morphology-based image processing can be used to remove such outliers.

To treat foreground and background differently, image segmentation is often used. However, accurate segmentation is an expensive process. For computational efficiency, the depth image 400 is divided into multiple layers with thresholding.

For example, the depth image 400 is divided into a number of depth layers, each depth layer having a layer number. The total number of the depth layer depends on various factors. One factor is the maximum depth range of the ToF camera. Another factor is the thresholding. This factor can be used to control the depth range of each depth layer such that this depth layer represents a bin that includes pixels having depth values within the depth range.

For instance, the maximum depth range is three meters and the threshold is set to 0.5 meters (or to a value between 0.4 meters and 0.6 meters). In this illustration, six layers would be created and the difference between two consecutive layers is 0.5 meters (of the value of the thresholding). The first layer would include pixels having depth between 0 and 0.5 meters, the next layer would include pixels having depth between 0.5 meters and one meter, and so on and so forth until the last layer that includes pixels having depth between 2.5 and 3.0 meters.

In addition, if a layer has a number of pixels smaller than a predefined threshold number tₚᵢₓₑₗ, the layer can be disregarded. Doing so can speed up the processing of the depth image 400. Referring to the above illustration, if the fifth and sixth layers include less than twenty pixels each (or some other predefined threshold number tₚᵢₓₑₗ), these two layers are deleted.

As illustrated in FIG. 4, the resulting division of the depth image 400 includes four layers (shown as L₁, L₂, L₃, and L₄), where the first layer L₁ has the smallest depth and the layer L₄ has the largest depth. In the above illustration, the layer L₁ has a depth range between 0 and 0.5 meters, the layer L₂ has a depth range between 0.5 meters and one meter, the layer L₃ has a depth range between one meter and 1.5 meters, and the layer L₄ has a depth range between 1.5 and 2.0 meters. The last two layers are removed for not having a sufficient number of pixels.

As further illustrated in FIG. 4, outliers exist on the boundaries between the layers and are more frequent as the layers are more spaced apart. For instance, the frequency of outliers and the possible regions of outliers are much larger on the boundary between the layers L₁ and L₄, than the boundary between the layers L₂ and L₄, and may not exist between the layers L₃ and L₄. The boundaries that include outliers are shown with diagonal shading.

When considering the layers L₁ and L₄, pixels in the shaded boundary have incorrect depth values (due to sensor errors as explained herein above). These pixels' depth values are in the depth range of the first layer L₁ (e.g., between 0 and 0.5 meters). But in fact, these pixels' depth values should be in the depth range of the fourth layer L₄ (e.g., between 1.5 and 2.0 meters). Similarly, pixels in the shaded boundary between the second layer L₂ and the fourth layer L₄ are incorrectly sensed as belonging to the second layer L₂, when in fact they should belong to the fourth layer L₄.

The depth image 400 is updated (e.g., by the pre-processing component 310) to reduce or eliminate the outliers. The updating includes moving pixels in the shaded boundaries from the first layer L₁ or the second layer L₂, as applicable, to the fourth layer L₄.

Generally, each layer contains only pixels within a specific depth range. Each layer has thickness of λ=dₘₐₓ/l, where dₘₐₓ is the maximal working distance of the ToF camera and l is the number of layers. Each depth layer has a layer number and the layer numbers are ordered in an ascending order (e.g., L₁ is the nearest layer and L₁ is the farthest). As illustrated in FIG. 4, diagonally shaded regions represent the distortion region along depth edges. If the two sides of a depth edge are on consecutive layers, such as L₁ and L₂, the depth edge has less depth distortion and noisy region is small. If two sides are on non-consecutive layers, the depth distortion can be severe depending on the gap (e.g., the difference between depth values of foreground and background). As illustrated in FIG. 4, the distortion region between L₁ and L₄ is bigger than that between L₂ and L₄. When dividing the depth map into layers, if the number of pixels on one layer is smaller than a threshold tₚᵢₓₑₗ, this layer is ignored. Based on the gaps between different depth layers, morphological dilation is performed on the depth layers from far to near. The purpose of dilation is to propagate the depth values from far layer to the distortion region on the nearer depth layer which should belong to the far depth layer if not for the depth distortion problem.

FIG. 5 illustrates an example of an update to a depth image, according to at least one aspect of the disclosure. In an example, the update involves morphological dilations performed on depth layers from far to near (e.g., from relatively larger depth ranges to relatively smaller depth ranges). However, the embodiments of the present disclosure are not limited as such. For instance, the update may additionally or alternatively include morphological erosions performed on depth layers from near to far.

In an embodiment, the update involves a set of update rules. A first update rule specifies that morphological dilation is to be performed on depth layers from far to near. A second update rule specifies that depth distortion between consecutive depth layers can be ignored. In other words, when two depth layers are selected for a morphological dilation, only non-consecutive layers may be selected (e.g., the difference between the layer numbers of the selected depth layers is equal to or larger than two). A third update rule specifies that a depth layer with a number of pixels smaller than a threshold tₚᵢₓₑₗ can be ignored. A fourth update rule specifies that the size of the kernel used for a morphological dilation can depend on the difference between the layer numbers of the selected layers. A fifth update rule specifies that, for iterative application of a dilation operation to two selected layers, the size of the kernel decreases with the number of iterations. A sixth update rule specifies that morphological dilations can be iteratively applied αcross different pairs of selected depth layers.

As illustrated in FIG. 5, a true depth image 510 (e.g., a depth image that is distortion free) is divided into multiple depth layers including layers Lᵢ and Lⱼ. In comparison, a received depth image 510 (e.g., the same depth image that is generated by a ToF camera and that includes edge distortions) can be similarly divided into multiple layers including layers Lᵢ and Lⱼ. However, because of the edge distortion, the layer Lᵢ in the received depth image 520 is different from (e.g., smaller than) the layer Lᵢ in the true depth image 510. Similarly, layer Lⱼ in the received depth image 520 is different from (e.g., larger than) the layer Lⱼ in the true depth image 510. The purpose of the update is to adjust layers Lᵢ and Lⱼ in the received depth image 520 to approximate layers Lᵢ and Lⱼ, respectively, in the true depth image 510. The adjusting includes moving pixels of the distortion edge from one layer to another layer.

The update can start with selecting the layers Lᵢ and Lⱼ in the received depth image 520. The difference between the layer numbers (e.g., i-j) should be equal to or larger than two. In this example, the layer Lᵢ is deeper than the layer Lⱼ. Next, a morphological dilation operation is applied to the layer Lᵢ, where the kernel's size is based on the difference “i-j.” This operation results in an intermediary processed image 540, where the layer Lᵢ is expanded and the layer Lⱼ is shrunk. A masking operation 545 is applied to the processed image 540. In particular, a non-zero mask that corresponds to the layer Lⱼ prior to the dilation operation 530 is applied to the processed image 540. The result of the masking operation 545 is yet another intermediary processed image 550. A comparison operation 560 is applied to the processed image 550, whereby this processed image 550 can be compared to the received depth image 520 to determine the change to the layers Lᵢ and Lⱼ. The result of the comparison operation 560 is another processed image 570, and the change to the layers Lᵢ and Lⱼ is shown in the processed image 570 as a shaded area. These various operations are repeated for different pairs of selectable layers. The update operation 580 in FIG. 5 corresponds to this iterative processing. Once the iterative processing is complete, an updated depth image 590 is generated. This updated depth image 590 approximates the true depth image 510.

In example, the above update process can be defined in an algorithm implemented by an AR module (e.g., or more specifically by a pre-processing component of the AR module). The algorithm can be expressed as:

Data: Depth image D divided into l multiple layers L₁, L₂, . . . , Lₗ, and corresponding non-zero masks M₁, M₂, . . . , Mₗ.

| 1 | Dₒᵤₜ ← Lₗ, i ← 3; | | | |
|---|---|---|---|---|
| 2 | while i ≤ l do | | | |
| 3 | \| | j ← i − 2, L_{cur} = Lᵢ; | | |
| 4 | \| | while j ≥ 1 do | | |
| 5 | \| | \| | Dilation operation on L_{cur}; | |
| 6 | \| | \| | if Lⱼ exists then | |
| 7 | \| | \| | \| | Lₜₑₘₚ ← L_{cur} masked by Mⱼ; |
| 8 | \| | \| | \| | if number of non-zero pixel of Lₜₑₘₚ > tₚᵢₓₑₗ then |
| 9 | \| | \| | \| | └ Dₒᵤₜ ← Dₒᵤₜ + Lₜₑₘₚ^{nonzero}, j ← j − 1; |
| | \| | \| | └ | |

| | | |
|---|---|---|
| | \| | └ |
| 10 | └ | Dₒᵤₜ ← Dₒᵤₜ + L_{cur}^{nonzero}, i ← i + 1 |

After outlier removal as illustrated in connection with FIGS. 4-5, depth maps are further processed for visual occlusion handling. Due to hardware limitations, ToF cameras typically have low spatial resolution. Thus, embodiments of the present invention perform a registration operation to register the depth samples to the frame of high resolution RGB image then densify the sparse depth map. The depth edge between an occluding object and the background needs to be temporally smooth while maintaining good discontinuity. Finally, the processing should be completed in real time with limited computing resources. To overcome these challenges, a processing pipeline (e.g., one corresponding to the upper stream in FIG. 3) includes registration, morphology-based depth densification, smooth filtering, up-sampling, and alpha blending.

FIG. 6 illustrates an example of a registration of a depth image with an RGB image, according to at least one aspect of the disclosure. The registration can be the first operation in the processing pipeline.

As illustrated, a depth sensor 610 and an RGB optical sensor 620 are installed in a computer system. A transformation 630 exists between the depth sensor 610 and the RGB optical sensor 620. Although the two sensors 610 and 620 may have similar field of views (FOVs), their FOVs partially, rather than fully, overlap because of the transformation 630. FIG. 6 shows the overlap as a FOV overlap 615 between the two most inner dotted lines.

The depth sensor 610 and the RGB optical sensor different image resolutions. In other words, the depth sensor 610 generates a depth image 612 and the RGB optical sensor 620 generate an RGB image 622, where the depth image 612 has a lower image resolution than the RGB image 622. FIG. 6 illustrates the lower resolution by showing depth pixels 614 of the depth image 612 as being sparse.

Because of the partial FOV overlap 615, the depth image 612 and the RGB image 622 partially, rather than fully, overlap too. FIG. 6 shows the overlap as a as an image overlap 650 between the depth image 612 and the RGB image 622.

In an example, the registration only considers the depth pixels 614 that fall in the image overlap 650. Depth pixels outside of the image overlap 650 (e.g., to the left of the image overlap 650 in FIG. 6) are ignored. Likewise, RGB pixels falling in the image overlap 650 are considered and remaining RGB pixels are ignored. The locations in the depth image 612 of the considered depth pixels 614 (e.g., their pixel indices) are associated with the locations in the RGB image 622 of the considered RGB pixels (e.g., their pixel indices) based on their correspondences. For instance, depth pixel “m” is associated with RGB pixel “n” when these two pixels overlap in the image overlap 650. More specifically, the depth pixel “m” is projected to a 3D coordinate M based on the coordinates of the pixel “m”, the depth value of “m”, and depth camera's intrinsic parameters. Then, 3D point M is transformed to 3D point N based on the extrinsic transformation between the ToF camera and RGB camera. 3D point N is then projected onto the RGB pixel “n” based on the intrinsic parameter of RGB camera. The intrinsic parameters of ToF camera and those of RGB camera, and the extrinsic transformation between the ToF camera and RGB camera can be established during a device calibration step.

In an example, a ToF camera is used and has a low resolution of 240×180. An RGB camera is also used to generate an RGB image at a higher resolution (1920×1280). In order to complete the entire pipeline in real time, depth images are registered with a down-sampled RGB image at 480×320.

Once registration is complete (e.g., the association between the depth pixels and the RGB pixels are generated), a depth densification operation can be applied. In an example, a non-guided depth up-sampling method is used, which is computationally fast. The depth densification operation includes three morphology operations. First, a dilation is performed with a diamond kernel to fill in most of the empty pixels. Then, a full kernel morphological close operation is applied to fill in the majority of holes. Finally, to fill in larger holes (usually very rare), a large full kernel dilation is performed. The kernel sizes can be carefully tuned based on different ToF cameras.

Thereafter, a filtering operation is applied. In particular, during densification, the morphological operations might generate incorrect depth values. Therefore, smoothing can be used to remove noises while keeping local edge information. A median filter can be applied for this purpose. A foreground mask is also generated for occluding objects using simple depth thresholding. Then Gaussian blur is applied to the mask to create an alpha map and also smooth the edges in depth image.

The filtered depth image (480×320) is up-sampled to full RGB resolution (1920×1080) to enable visual occlusion rendering. This can be done in a GPU with nearest interpolation. At the same time, the alpha map is also scaled to full resolution.

In the rendering step, with a full-resolution depth image and an alpha map, alpha blending is utilized for compositing the final image. An example of the occlusion rendering is further illustrated in connection with the next figure.

FIG. 7 illustrates an example of rendering an AR scene based on occlusion detection that uses an RGBD image 710, according to at least one aspect of the disclosure. In an example, the RGBD image 710 represents a depth image that has been registered, depth densified, filtered, and up-sampled to a resolution of an RGB image. Each pixel in the RGBD corresponds to an RGB pixel of the RGB image and to a depth pixel of the depth image based on the registration. Accordingly, each RGB pixel has an RGB value of the corresponding RGB pixel and has a depth value of the corresponding depth pixel. The depth values in the RGBD image 710 are compared to depth values of a virtual object 720 and, if occlusion is detected based on the depth comparison, an alpha map 730 can be used for edge smoothing.

In particular, the occlusion rendering involves a blending operation 750. In an example, the RGBD image 710, the virtual object 720, and the alpha map 730 are input to the blending operation 750. This operation compares depth values of the RGBD image 710 and of the virtual object 720 for overlapping pixels.

When a pixel to be rendered in an AR image corresponds to a first pixel of the RGBD image 710 and to a second pixel of the virtual object 720 (the first and second pixels are the same in the rendering buffer, the depth of the two pixels are compared to determine whether the second pixel should be occluded in the rendering or not. The depth of the first pixel is determined from the RGBD image 710. The depth of the second pixel can be retrieved from a buffer and can be defined by an AR application. The blending operation 750 then compares this depth to the depth of the second pixel. If equal to or smaller than the depth of the second pixel, the first pixel occludes the second pixel. In this case, the blending operation 750 generates a smoothing factor for the first pixel based on the alpha map. The RGB value for the pixel in the AR image is set based on a first RGB value of the first pixel, a second RGB value of the second pixel, and the smoothing factor. For instance, the smoothing factor is set as α=1−mᵢ/255, where the RGB value is set as cᵢ^{r}=(1−α)cᵢ+αcᵢ^{o}, and wherein “α” is the smoothing factor, “i” is the pixel, a “mᵢ” is a value determined for the pixel from the alpha map, “cᵢ^{r}” is the RGB value, “cᵢ” is the first RGB value, and “cᵢ^{o}” is the second RGB value. However, if larger than the depth of the second pixel, the first pixel does not occlude the second pixel. In this case, the blending operation 750 sets the RGB value for the pixel in the AR image to be equal to an RGB value of the second pixel (e.g., α=1).

In example, the above rendering can be defined in an algorithm implemented on a GPU. The algorithm can be expressed as:

Data: For pixel i: dᵢ—depth value from ToF camera; mᵢ—alpha map value; cᵢ—color from RGB camera; dᵢ⁰—depth of virtual object from depth buffer; cᵢ^{o}—shaded color of the virtual object. cᵢ^{r}—final color of the current pixel i.

| | |
|---|---|
| 1 | if dᵢ <= dᵢ^{o} then |
| 2 | \| α = 1 − mᵢ/255 |
| 3 | else |
| 4 | └ α = 1.0 |
| 5 | cᵢ^{r} = (1 − α)cᵢ + αcᵢ^{o} |

FIG. 8 illustrates an example of a 3D model 810 of a real-world environment and a bounding box 860 of a virtual object 850, according to at least one aspect of the disclosure. In particular, after outlier removal, a depth image is used to generate the 3D model 810 in a coordinate system 820 of the AR session. The 3D model includes multi-level voxels, where each of such voxels includes a first voxel 830 at a first layer and multiple voxels 840 at a second layer, where the first layer has a lower resolution than the second layer. The bounding box 860 can bound the virtual object by a certain margin. Fast collision detection is performed by determining whether the bounding box 860 overlaps with any of the first level voxels 830, and if so, the second level voxels 840 of the overlapped first layer voxel(s) 830 are further considered to detect a higher resolution of the collision location. The collision can be prevented from the rendering, whereby, for instance, the virtual object 850 is prohibited from being moved into the location of the collision. Although a single bounding box 860 is illustrated in FIG. 8, multiple bounding boxes are likewise possible. For instance, multiple bounding boxes can contain the virtual object 850, can but need not be centered around a same point (e.g., the center of the virtual object 850), and/o can but need not have different sizes.

FIG. 9 illustrates an example of a hashing representation 910 of a multi-level voxel, according to at least one aspect of the disclosure. The multi-level voxel includes a first level voxel and multiple second level voxels, similar to a first level voxel 830 and second level voxels 840, respectively, of FIG. 8. Here, the hashing can speed up the collision detection, whereby hash values of the voxels are compared to hash values of the location of the one or more bounding boxes around a virtual object to determine whether an overlap exists or not.

In an example the hashing representation 910 is defined as a hash map. A hashing function 920 is applied to a first level voxel 925. The resulting hash value is stored in the hash map and is used as a spatial index of the first level voxel 925. Similarly, a hashing function 930 is applied to a second level voxel 935. The resulting hash value is also stored in the hash map and is used as a spatial index of the second level voxel 935.

There are a few representations for 3D data, such as point cloud. The depth data captured by a depth sensor can be used for fast 3D representation, while the data structure shall support fast collision detection. As described in connection with FIGS. 8-9, voxels can be used to represent the coarse shape of the 3D scene, which reduces the memory storage, while also providing faster construction speed and supporting fast collision detection. Although the data structure lacks geometric details, in general detailed geometry may not be needed for collision detection, unless an accurate response is needed.

In an example, cubes are used as unit voxels of the proposed data structure. The resolution of the data structure can be adjusted by changing the size of the unit voxel “c.” A two-level voxel data structure is generated as illustrated in FIG. 8. The first level of the structure stores large voxels which are indexed by a spatial hashing function as illustrated in FIG. 9. The spatial hashing function can be defined as: H(x, y, z)=(x·p₁⊕y·p₂ ⊕z·p₃), where ⊕ is an XOR operation, p₁, p₂, and p₃ are large prime numbers (e.g., p₁=73856093; p₂=19349663; p₃=83492791) and n is the hash table size.

In the second level, each big voxel is subdivided into smaller voxels, with the resolution of m*n*l. Then each small voxel is also indexed by a regular hash function.

When an AR session starts, a user scans the environment by moving their computer system around. Once a simultaneous localization and mapping (SLAM) operation is successfully initialized, 6DoF pose of the ToF camera is continuously tracked. 3D data structure reconstruction can be performed on each ToF frame at thirty fps. Using the ToF camera pose, ToF depth frame is first transformed into a point cloud in the coordinate frame of the AR session. A plane detection step is simultaneously performed to detect the horizontal supporting plane using a random sample consensus (RANSAC) based plane detection algorithm. The supporting plane is where the 3D model will be placed on. The 3D point samples belonging to this plane can be removed to speed up the voxelization and reduce data storage. By using motion sensing hardware on the computer system, the direction of gravity can be obtained. This enables to find the horizontal plane efficiently.

For each remaining point, its coordinates (x,y,z) are then divided by the first-level grid cell size c, and rounded down to integer index (i,j,k). Then the integer index is hashed using the above spatial hashing function to check whether the first level voxel exists (e.g., indexed in a hash map). If not, a new voxel is generated and the hash map is updated to include the hash value. If a voxel exists, then the (x,y,z) coordinates are transformed and rounded into integer index of the second level: (i′,j′,k′). This index is also hashed to check whether the second level voxel exists (e.g., indexed in the hash map). If not, a second level voxel is generated and its hash value is stored in the hash map.

To improve robustness and temporal consistency, a queue with s-bit is stored in each second level voxel. Each bit stores a binary value to represent whether this voxel is “seen” or not by the current ToF frame or a ToF frame in the past (e.g., a sequenced queue that includes bits, where each bit is associated with a different depth image and indicates whether the second level voxel corresponds to a 3D point that is visible in the different depth image). A“1” value can indicate a seen state. When processing a ToF frame, the oldest bit is popped from the queue and a new bit is inserted (e.g., an end bit from an end of the sequenced queue is removed and a start bit at a start of the sequences queue is inserted). If the number of “1” bits is bigger than a threshold number tₛ, then this voxel is used for collision detection for the current frame.

Such a two-level data structure can be used for fast collision detection, because each voxel represents an axis-aligned bounding box (AABB). In AR applications, a virtual object can also be represented by an AABB. During collision detection, all the first level voxels that potentially intersect with the virtual object's AABB are found first. These voxels are then looked up in the hash map using the spatial hashing function. Each lookup can be done in constant time. If one voxel exists in the map, second level valid voxels are checked for collision detection. All the m*n*l voxels are iterated to check whether such voxel exists in the hash map. If any voxel exists, intersection test is performed between the second level voxel and the AABB of the virtual object. To improve robustness, a collision is detected only when the number of collided voxels is larger than a threshold number L. Once the collision is detected between the static scene and the moving virtual object, the motion of the object is stopped to simulate the visual effect of collision avoidance.

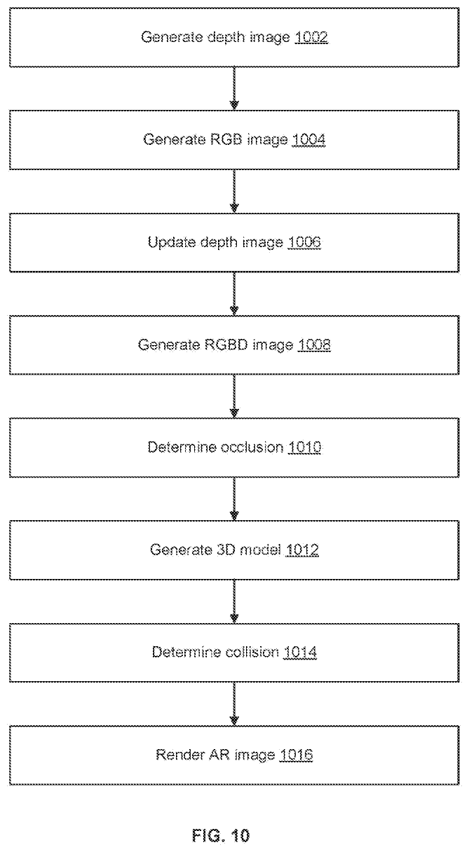

FIGS. 10-13 illustrate example flows for occlusion and collision detection and rendering, according to embodiments of the present disclosure. The flows are described in connection with a computer system that is an example of the computer system 110 of FIG. 1. Some or all of the operations of the flows can be implemented via specific hardware on the computer system and/or can be implemented as computer-readable instructions stored on a non-transitory computer-readable medium of the computer system. As stored, the computer-readable instructions represent programmable modules that include code executable by a processor of the computer system. The execution of such instructions configures the computer system to perform the respective operations. Each programmable module in combination with the processor represents a means for performing a respective operation(s). While the operations are illustrated in a particular order, it should be understood that no particular order is necessary and that one or more operations may be omitted, skipped, and/or reordered.

FIG. 10 illustrates an example of a flow for AR scene rendering based on occlusion and collision detections, according to at least one aspect of the disclosure. In an example, the flow starts at operation 1002, where the computer system generates a depth image. For instance, the computer system includes a ToF camera and the ToF camera is operated to generate the depth image in an AR session.

In an example, the flow includes operation 1004, where the computer system generates an RGB image. For instance, the computer system includes an RGB camera and the RGB camera is operated to generate the RGB image in the AR session. The depth image and the RGB image can be generated at the same time or substantially the same time (e.g., within an acceptable time difference from each other, such as a few milliseconds).

In an example, the flow includes operation 1006, where the computer system updates the depth image. For instance, pre-processing of the depth image is performed to remove outliers by dividing the depth image into depth layers and moving at least a pixel from a first depth layer to a second depth layer of the depth layers. Generally, the update is iterative between the different layers and follows a set of update rules as described in connection with FIGS. 4-5.

In an example, the flow includes operation 1008, where the computer system generates an RGBD image. For instance, the RGBD image is generated based on the depth image as updated and the RGB image. In particular, a registration, depth densification, filtering, and up-sampling are performed on the depth image as described in connection with FIG. 6. Each pixel in the RGBD image corresponds to a pixel of the RGB image and a pixel of the depth image as updated. The RGBD pixel has an RGB value of the RGB pixel and a depth value of the depth pixel.

In an example, the flow includes operation 1010, where the computer system determines occlusion between a virtual object and the RGBD image. For instance, the depth of each RGBD pixel (or a set of the RGBD pixels that overlap with the virtual object) is compared to the depth of the virtual object. If the RGBD pixel's depth is smaller than or equal to the virtual object's depth, the RGBD pixel occludes the virtual object. A smoothing factor is then set based on an alpha map.

In an example, the flow includes operation 1012, where the computer system generates a 3D model. For instance, the computer system generates a set of 3D points, such as point cloud, in a coordinate system of the AR session as described in connection with FIG. 8. Each 3D point corresponds to a depth pixel. For each of the 3D points, a multi-level voxel can be defined and each of the voxels can be indexed with a hash value as described in connection with FIG. 9.

In an example, the flow includes operation 1014, where the computer system determines a collision between the virtual object and another object in the AR scene (e.g., one shown in the RGBD image). For instance, one or more bounding boxes are defined around the virtual object. Collision between the bounding boxes and a first level voxel triggers a detection of the second level voxels that collide with the bounding boxes.

In an example, the flow includes operation 1016, where the computer system renders an AR image based on the occlusion determination and the collision determination. For instance, the computer system renders the virtual object in an AR scene of the AR session based on the depth of the virtual object, the RGBD image, and the collision. In particular, when the virtual object is deeper than certain RGBD pixels, the smoothing factor is applied given the alpha map. In addition, when collision is detected, motion of the virtual object can be stopped to simulate visual effect of collision avoidance.

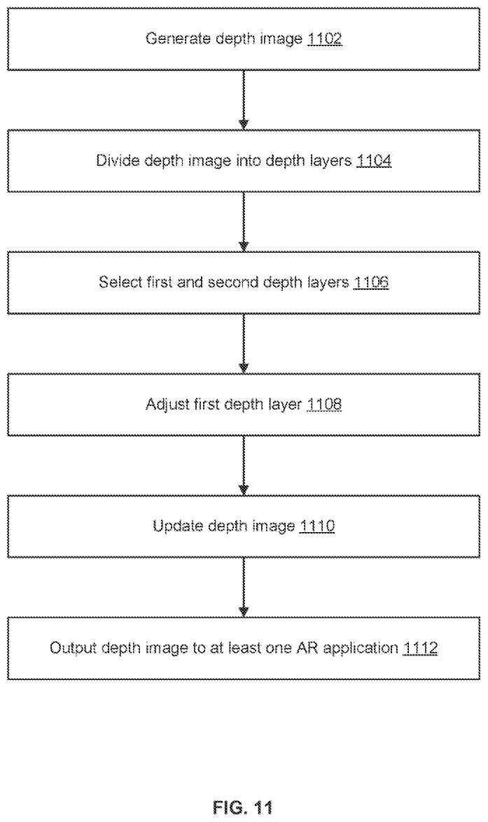

FIG. 11 illustrates an example of a flow for updating a depth image, according to at least one aspect of the disclosure. The flow can be implemented as sub-operations of operation 1006 of FIG. 10.

In an example, the flow of FIG. 11 starts at operation 1102, where the computer system generates a depth image. In an example, the flow include operation 1104, where the computer system divides the depth image into depth layers. Each depth layer corresponds to a depth range and includes pixels having depth values within the depth range. If a depth layer includes a total number of pixels that is smaller than a predefined threshold number, the depth layer can be ignored from the remaining operations of the flow.

In an example, the flow includes operation 1106, where the computer system selects a first depth layer and a second depth layer. The first depth layer has a first layer number. The second depth layer has a second depth layer. The selection can be based on, for instance, the layer numbers of the depth layers. In particular, a selection rule may specify that two consecutive depth layers cannot be selected. In this case, the difference between the first and second layer numbers is equal to or larger than two.

In an example, the flow includes operation 1108, where the computer system adjusts the first layer. Different adjustment operations are possible. For instance, a morphological dilation is possible. In this case, the first layer number is larger than the second layer number (e.g., the first depth layer is deeper than the second depth layer) and morphological dilation operations are applied to depth layers from far to near. In another illustration, a morphological erosion is possible. In this case, the first layer number is smaller than the second layer number (e.g., the second depth layer is deeper than the first depth layer) and morphological erosion operations are applied to depth layers from near to far. The size of the kernel can depend on the difference between the layer numbers. The adjustment can be iterative αcross different pairs of selectable layers.

In an example, the flow includes operation 1110, where the computer system updates the depth image. For instance, once the morphological dilation operations (and/or morphological erosion operations) are completed, the layers as adjusted form the updated depth image.

In an example, the flow includes operation 1112, where the computer system outputs the depth image to at least one AR application. For instance, the depth image as updated is sent to a first application pipeline that detects occlusion. The depth image as updated is also sent to a second application pipeline that detects collision.

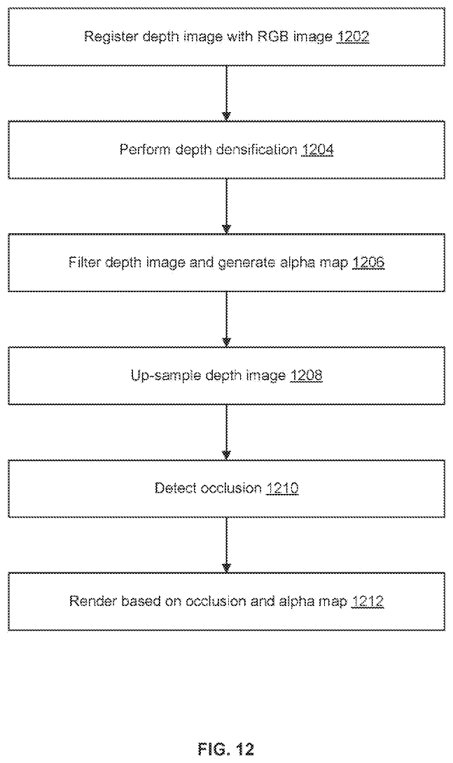

FIG. 12 illustrates an example of a flow for occlusion detection, according to at least one aspect of the disclosure. The flow can be implemented as sub-operations of operations 1008-1010 of FIG. 10.

In an example, the flow of FIG. 12 starts at operation 1202, where the computer system registers the depth image with the RGB image. For instance, the registration depends on a known transformation between the TOF camera and the RGB camera. In particular, an overlap between the two images is determined and only pixels that fall in the overlap are considered. For these pixels, the computer system determines overlapping pairs of depth pixel and RGB pixel. The index in the depth image of a depth pixel is associated with the index in the RGB image of an RGB pixel where the depth pixel and the RGB pixel overlap.

In an example, the flow includes operation 1204, where the computer system performs a depth densification on the depth image. For instance, one or more morphological dilation operations are applied to the depth image.

In an example, the flow includes operation 1206, where the computer system filters the depth image, after the depth densification, and generates an alpha map. For instance, a median filter is applied. A foreground mask is also applied to depth image and Gaussian blur is applied to the mask to generate the alpha map.

In an example, the flow includes operation 1208, where the computer system up-samples the depth image after the filtering. For instance, the depth image is up-sampled to the resolution of the RGB image. Similarly, the alpha map is up-sampled to the resolution of the RGB image.

In an example, the flow includes operation 1210, where the computer system detects occlusion. For instance, the depth of each pixels from the up-sampled depth image (or a set of the depth pixels that overlap with the virtual object) is compared to the depth of the virtual object. If the depth pixel is deeper than the virtual object, occlusion is detected.

In an example, the flow includes operation 1212, where the computer system renders pixels in the AR image based on the occlusion detection. For instance, the occlusion detection identifies the different depth pixels that occlude the virtual object. Based on the registration, the corresponding RGB pixels are determined. A smoothing factor is set based on values corresponding to these RGB pixels from the alpha map. The rendering is performed according to the values of the smoothing factors, the RGB pixels of the RGB image, and the RGB pixels of the virtual object.

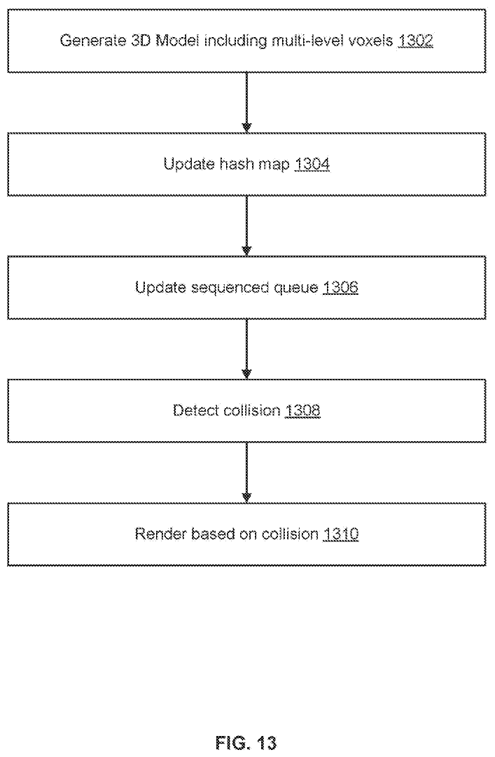

FIG. 13 illustrates an example of a flow for collision detection, according to at least one aspect of the disclosure. The flow can be implemented as sub-operations of operations 1012-1014 of FIG. 10.

In an example, the flow of FIG. 13 starts at operation 1302, where the computer system generates a 3D model including multi-level voxels. For instance, the depth image as updated per the flow of FIG. 11 is converted into a point cloud in the coordinate system of the AR session. Each coordinates (x,y,z) of the point cloud is used to define, if one is not already existent, a first level voxel and a second level voxel at a higher resolution.

In an example, the flow include operation 1304, where the computer system updates a hash map. For instance, for each voxel (at the first level or the second level), the coordinates (x,y,z) are divided by the resolution of the voxel level and rounded down to generate indices and a hashing operation is applied to the indices. The resulting hash value is looked up in the hash map and, if not present, the hash map is updated to include the hash value.

In an example, the flow includes operation 1306, where the computer system updates a sequenced queue. For instance, a sequenced queue is stored in each second level voxel and contains bits having binary values. A “1” bit indicates that the second level voxel corresponds to a visible portion at the instant when a past ToF frame is captured. A “0” bits indicates otherwise. When processing a ToF image, the oldest bit is removed and the latest bit corresponding to the current ToF image is inserted in the sequenced queue. Only if the number of “1” bits is larger than a predefined threshold number, the second level voxel is considered for collision detection.

In an example, the flow includes operation 1308, where the computer system detects collision. For instance, one or more bounding boxes are defined around the virtual object. The computer system finds all first level voxels that potentially interest with the bounding boxes. The computer system then look up these candidate voxels in the hash map using the hashing function that was applied to the first level voxels. If one voxel exists in the hash map, second level voxels included in that first level voxel are checked for collision detection based on their corresponding hash values in the hash map. If any voxel exists, intersection test is performed between the second level voxel and the bounding boxes of the virtual object. Collision can be detected only when the number of collided voxels is larger than a threshold number.

In an example, the flow includes operation 1310, where the computer system renders pixels in the AR image based on the collision detection. For instance, the collision detection identifies the different depth pixels that potentially collide with the virtual object. Based on the registration, the corresponding RGB pixels are determined. The rendering is performed such that to avoid placing the object in an overlapping manner with these RGB pixels.

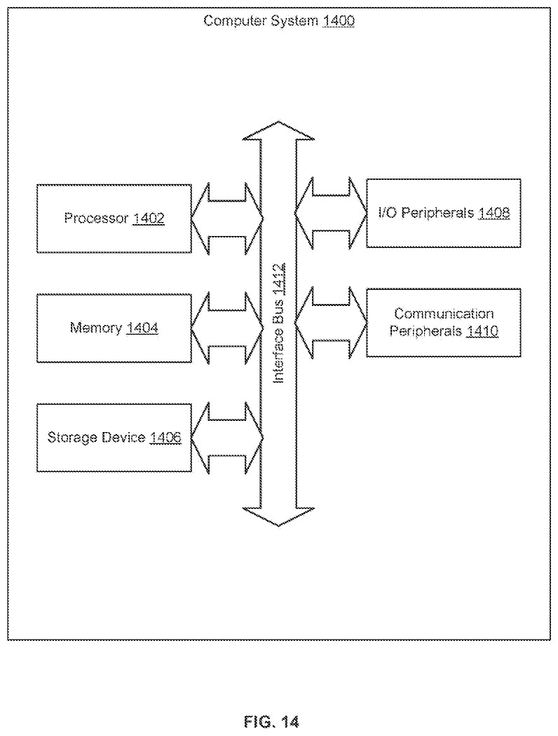

FIG. 14 illustrates examples of components of a computer system 1400 according to certain embodiments. The computer system 1400 is an example of the computer system 110 of FIG. 1. Although these components are illustrated as belonging to a same computer system 1400, the computer system 1400 can also be distributed.

The computer system 1400 includes at least a processor 1402, a memory 1404, a storage device 1406, input/output peripherals (I/O) 1408, communication peripherals 1410, and an interface bus 1412. The interface bus 1412 is configured to communicate, transmit, and transfer data, controls, and commands among the various components of the computer system 1400. The memory 1404 and the storage device 1406 include computer-readable storage media, such as RAM, ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer readable storage media can be configured to store instructions or program codes embodying aspects of the disclosure. The memory 1404 and the storage device 1406 also include computer readable signal media. A computer readable signal medium includes a propagated data signal with computer readable program code embodied therein. Such a propagated signal takes any of a variety of forms including, but not limited to, electromagnetic, optical, or any combination thereof. A computer readable signal medium includes any computer readable medium that is not a computer readable storage medium and that can communicate, propagate, or transport a program for use in connection with the computer system 1400.

Further, the memory 1404 includes an operating system, programs, and applications. The processor 1402 is configured to execute the stored instructions and includes, for example, a logical processing unit, a microprocessor, a digital signal processor, and other processors. The memory 1404 and/or the processor 1402 can be virtualized and can be hosted within another computer system of, for example, a cloud network or a data center. The I/O peripherals 1408 include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 1408 are connected to the processor 1402 through any of the ports coupled to the interface bus 1412. The communication peripherals 1410 are configured to facilitate communication between the computer system 1400 and other computing devices over a communications network and include, for example, a network interface controller, modem, wireless and wired interface cards, antenna, and other communication peripherals.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computer system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “including,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A method implemented by a computer system, the method including:
generating, in an augmented reality (AR) session and based on a depth sensor of the computer system, a depth image;
dividing the depth image into depth layers, each depth layer corresponding to a depth range and including pixels having depth values within the depth range;
selecting, from the depth layers, a first depth layer having a first layer number and a second depth layer having a second layer number;
adjusting the first depth layer based on the first layer number, first pixels in the first depth layer, the second layer number, and second pixels in the second depth layer, wherein the adjusting includes moving a pixel from the second depth layer to the first depth layer;
updating the depth image based on the adjusting; and
outputting the depth image as updated to at least one AR application associated with the AR session.

2. The method of claim 1, wherein a total number of the depth layers is based on a maximum depth of the depth sensor.

3. The method of claim 1, wherein a difference between depth ranges of two consecutive depth layers is between 0.4 meters and 0.6 meters.

4. The method of claim 1, wherein the first depth layer and the second depth layer are selected based on a difference between the first layer number and the second layer number being equal to or larger than two.

5. The method of claim 4, wherein the first depth layer and the second depth layer are selected further based on each of a total number of the first pixels and a total number of the second pixels being equal to or larger than a predefined threshold number.

6. The method of claim 1, wherein the first layer number is larger than the second layer number, and wherein adjusting the first depth layer includes performing a morphological dilation from the first depth layer to the second depth layer.

7. The method of claim 6, wherein a size of a kernel of the morphological dilation is based on a difference between the first layer number and the second layer number.

8. The method of claim 6, wherein the morphological dilation is iteratively repeated for a number of iterations, and wherein the number of iterations is based on a difference between the first layer number and the second layer number.

9. The method of claim 1, further including:
generating, in the AR session and based on a red, green, and blue (RGB) optical sensor of the computer system, an RGB image;
generating, based on the depth image as updated and the RGB image, an RGB depth (RGBD) image;
generating, based on the depth image as updated, a set of three dimensional (3D) points in a coordinate system of the AR session;
generating, based on the depth image, a 3D model that includes multi-level voxels, wherein a multi-level voxel of the multi-level voxels is associated with a 3D point from the set;
determining a collision between a virtual object and the multi-level voxel; and
rendering, in the AR session, the virtual object based on a depth of the virtual object and the RGBD image and based on the collision.

10. A computer system including:
a depth sensor configured to generate a depth image in an augmented reality (AR) session;
a red, green, and blue (RGB) optical sensor configured to generate an RGB image in the AR session;
one or more processors; and
one or more memories storing computer-readable instructions that, upon execution by the one or more processors, configure the computer system to:
update the depth image by at least dividing the depth image into depth layers and moving a pixel from a first depth layer to a second depth layer of the depth layers;
generate, based on the depth image as updated and the RGB image, an RGB depth (RGBD) image;
generate, based on the depth image as updated, a set of three dimensional (3D) points in a coordinate system of the AR session;
generate a 3D model that includes multi-level voxels, wherein a multi-level voxel of the multi-level voxels is associated with a 3D point from the set;
determine a collision between a virtual object and the multi-level voxel; and
render, in the AR session, the virtual object based on a depth of the virtual object and the RGBD image and based on the collision.

11. The computer system of claim 10, wherein each depth layer corresponds to a depth range and includes pixels having depth values within the depth range, and wherein updating the depth image further includes:
selecting, from the depth layers, the first depth layer and the second depth layer based on a first layer number of the first depth layer and on a second layer number of the second depth layer; and
adjusting the second depth layer based on the first layer number, first pixels in the first depth layer, the second layer number, and second pixels in the second depth layer, wherein the adjusting includes moving the pixel from the first depth layer to the second depth layer.

12. The computer system of claim 10, wherein generating the RGBD image includes:
registering the depth image with the RGB image based on an image resolution of the depth image, an image resolution of the RGB image, and a transformation between the depth sensor and the RGB optical sensor;
performing a depth densification on the depth image, the depth densification including a plurality of morphological dilation on the depth image;
filtering, subsequent to the depth densification, the depth image based on a median filter; and
up-sampling the depth image as filtered to the image resolution of the RGB image based on the registering, wherein a pixel in the RGBD image corresponds to pixel in the RGB image and a pixel in the depth image as up-sampled.

13. The computer system of claim 10, wherein generating the RGBD image includes:
generating an alpha map from the depth image; and
up-sampling the depth image and the alpha map to an image resolution of the RGB image.

14. The computer system of claim 13, wherein rendering the virtual object includes:
determining that a pixel to be rendered in an AR image corresponds to a first pixel of the RGBD image and to a second pixel of the virtual object;
determining, from the RGBD image, a first depth of the first pixel;
determining that the first depth is smaller than or equal to a second depth of the second pixel;
generating a smoothing factor for the first pixel based on the alpha map; and
setting an RGB value for the pixel in the AR image based on a first RGB value of the first pixel, a second RGB value of the second pixel, and the smoothing factor.

15. The computer system of claim 14, wherein the smoothing factor is set as α=1−mᵢ/255, and wherein the RGB value is set as cᵢ^{r}=(1−α)cᵢ+αcᵢ^{o}, and wherein “α” is the smoothing factor, “i” is the pixel, a “mᵢ” is a value determined for the pixel from the alpha map, “cᵢ^{r}” is the RGB value, “cᵢ” is the first RGB value, and “cᵢ^{o}” is the second RGB value.

16. The computer system of claim 10, wherein rendering the virtual object includes:
determining that a pixel to be rendered in an AR image corresponds to a first pixel of the RGBD image and to a second pixel of the virtual object;
determining, from the RGBD image, a first depth of the first pixel;
determining that the first depth is larger than a second depth of the second pixel; and
setting an RGB value for the pixel in the AR image to be equal to an RGB value of the second pixel.

17. One or more non-transitory computer-storage media storing instructions that, upon execution on a computer system, cause the computer system to perform operations including:
generating, in an augmented reality (AR) session and based on a depth sensor of the computer system, a depth image;
generating, in the AR session and based on a red, blue, and green (RGB) optical sensor of the computer system, an RGB image;
updating the depth image by at least dividing the depth image into depth layers and moving a pixel from a first depth layer to a second depth layer of the depth layers;
generating, based on the depth image as updated and the RGB image, an RGB depth (RGBD) image;
generating, based on the depth image as updated, a set of three dimensional (3D) points in a coordinate system of the AR session;
generating a 3D model that includes multi-level voxels, wherein a multi-level voxel of the multi-level voxels is associated with a 3D point from the set;
determining a collision between a virtual object and the multi-level voxel; and
rendering, in the AR session, the virtual object based on a depth of the virtual object and the RGBD image and based on the collision.

18. The one or more non-transitory computer-storage media of claim 17, wherein the set of 3D points includes a point cloud, wherein the multi-level voxel includes a first voxel at a first level that has a first grid size and second voxels at a second level that has a second grid size smaller than the first grid size, and wherein generating the 3D model includes:
dividing coordinates of the 3D point by the first grid size to generate indexes of the 3D point;
hashing the indexes to determine a hash value;
determining that a hash map does not include the hash value; and
updating the hash map to include the hash value.

19. The one or more non-transitory computer-storage media of claim 17, wherein rendering the virtual object includes preventing the collision from being rendered by at least controlling movement of the virtual object, wherein the multi-level voxel includes a first voxel at a first level that has a first grid size and second voxels at a second level that has a second grid size smaller than the first grid size, and wherein determining the collision includes:
generating one or more bounding boxes around the virtual object;
determining a first intersection between the one or more bounding boxes and the first voxel;
determining, based on the first intersection, that the first voxel has a first hash value in a hash map;
determining, based on the first hash value being included in the hash map, a second intersection between the one or more bounding boxes and a second voxel from the second voxels;
determining, based on the second intersection, that the second voxel has a second hash value in the hash map; and
detecting the collision based on the second hash value being included in the hash map.

20. The one or more non-transitory computer-storage media of claim 17, wherein the multi-level voxel includes a first voxel at a first level that has a first grid size and second voxels at a second level that has a second grid size smaller than the first grid size, and wherein determining the collision includes:
storing, in association with a second voxel from the second voxels, a sequenced queue that includes bits, wherein each bit is associated with a different depth image and indicates whether the second voxel corresponds to a 3D point that is visible in the different depth image;
removing an end bit from an end of the sequenced queue;
inserting a start bit at a start of the sequenced queue, wherein the start bit is associated with the depth image;
determining that a total number of bits in the sequenced queue indicating that the second voxel is visible is larger than a predefined threshold number; and
detecting the collision based on the second voxel.
